(19) United States
(12) Patent Application Publication
(10) Pub. No.: US 2026/0213069 A1
(43) Pub. Date: Jul. 23, 2026

(54) MULTILAYER CERAMIC CAPACITOR

(71) Applicant: TAIYO YUDEN CO., LTD., Tokyo (JP)

(72) Inventor: Ayumi MATSUOKA, Tokyo (JP)

(21) Appl. No.: 19/443,286

(22) Filed: Jan. 8, 2026

(30) Foreign Application Priority Data
Jan. 22, 2025 (JP) 2025-009414

(51) Int. Cl. H01G 2/14; H01G 4/008; H01G 4/12; H01G 4/232; H01G 4/30

(52) U.S. Cl. CPC H01G 2/14; H01G 4/008; H01G 4/1227; H01G 4/232; H01G 4/30

(57) ABSTRACT

A multilayer ceramic capacitor is provided and includes: a body including a plurality of dielectric material layers and a plurality of internal electrode layers that are alternately laminated; and a plurality of intermediate regions one of which is provided between one dielectric material layer of the dielectric material layers and one internal electrode layer of the internal electrode layers, the one dielectric material layer and the one internal electrode layer being next to each other. The dielectric material layers contain a perovskite-type compound represented by general formula ABO₃. The intermediate regions contain copper. A thickness of the dielectric material layers is 1.6 μm or less. A ratio [a/t] is 0.8 or more and 7.0 or less, where a of the ratio [a/t] is a concentration (atomic %) of the copper in the intermediate regions, and t of the ratio [a/t] is the thickness (μm) of the dielectric material layers.

### CROSS-REFERENCE TO RELATED APPLICATIONS

This patent application is based on and claims priority to Japanese Patent Application No. 2025-009414 filed on Jan. 22, 2025, the entire contents of which are incorporated herein by reference.

### TECHNICAL FIELD

The present disclosure relates to a multilayer ceramic capacitor.

### BACKGROUND

Multilayer ceramic capacitors (MLCCs) have a structure in which dielectric material layers and internal electrode layers are alternately laminated. Also, multilayer ceramic capacitors are used in various electronic devices, such as mobile phones, personal computers, and the like.

In recent years, in response to progressing multifunctionality, increasing performance, and the like of electronic devices to be mounted, miniaturization, increased capacity, and the like of multilayer ceramic capacitors have been required. For meeting such requirements, it is effective to thin the dielectric material layers and the internal electrode layers to increase the number of laminated layers. However, thinning the dielectric material layers lowers the electric field intensity when the capacitors are used, potentially resulting in reduction in insulation reliability and the like.

In view of this, various studies have been conducted on a configuration in which desired characteristics can be obtained even if the dielectric material layers are thinned. Such a configuration that is known is a configuration in which a layer containing a different element is formed between the dielectric material layer and the internal electrode layer, thereby increasing interfacial resistance and improving insulation reliability of the multilayer ceramic capacitor. For example, Patent Document 1 describes a multilayer ceramic capacitor in which a diffusion-phase grain layer exists between the dielectric material layer and the internal electrode layer, and describes that degradation in insulation can be suppressed and lifetime characteristics can be improved.

### RELATED ART DOCUMENT

### Patent Document

Patent Document 1: Japanese Laid-Open Patent Application Publication No. 2006-319205

### SUMMARY

According to one aspect of the present disclosure, a multilayer ceramic capacitor includes: a body including a plurality of dielectric material layers and a plurality of internal electrode layers that are alternately laminated; and a plurality of intermediate regions one of which is provided between one dielectric material layer of the plurality of dielectric material layers and one internal electrode layer of the plurality of internal electrode layers, the one dielectric material layer and the one internal electrode layer being next to each other. The dielectric material layers contain a perovskite-type compound represented by general formula ABO₃. The intermediate regions contain copper. A thickness of the dielectric material layers is 1.6 μm or less. A ratio [a/t] is 0.8 or more and 7.0 or less, where a of the ratio [a/t] is a concentration (atomic %) of the copper in the intermediate regions, and t of the ratio [a/t] is the thickness (μm) of the dielectric material layers.

### BRIEF DESCRIPTION OF THE DRAWINGS

FIG. 1 is a perspective diagram of a multilayer ceramic capacitor according to an embodiment of the present disclosure.

FIG. 2 is a cross-sectional diagram taken along the line A-A of FIG. 1.

FIG. 3 is a cross-sectional diagram taken along the line B-B of FIG. 1.

FIG. 4 is a graph of a highly accelerated limit test (HALT) lifetime increase rate of a multilayer ceramic capacitor containing 1% copper (Cu) in internal electrode layers 12 compared to a conventional multilayer ceramic capacitor containing no copper (Cu) in internal electrode layers.

FIG. 5 is an enlarged diagram of region C of FIG. 2.

FIG. 6A is a graph of an example of analysis results obtained through transmission electron microscopy-energy dispersive X-ray spectroscopy (TEM-EDX) of the multilayer ceramic capacitor.

FIG. 6B is a graph of an example of analysis results obtained through TEM-EDX of the multilayer ceramic capacitor.

FIG. 7 is a flowchart illustrating a production method of the multilayer ceramic capacitor according to the embodiment.

### DETAILED DESCRIPTION

In conventional multilayer ceramic capacitors, there may be a case in which improvement in reliability due to an increase in interfacial resistance caused by the addition of a different element as described above cannot be sufficiently obtained. For example, when the thickness of the dielectric material layers is changed for adjustment of electrostatic capacitance, the interfacial ratio with the dielectric material layer is also changed. Thus, the contribution of the increase in the interfacial resistance is changed, and an expected lifetime value cannot be obtained in some cases.

According to one aspect of the present disclosure, it is possible to provide a multilayer ceramic capacitor having a long lifetime and excellent dielectric characteristics without being influenced by the thickness of the dielectric material layers.

Hereinafter, embodiments of the present disclosure will be described in detail, but the present disclosure is not limited to the embodiments. In the present specification and drawings, components having substantially the same functional configuration are denoted by the same reference signs, and thus duplicate description thereof may be omitted. In some of the drawings, an X axis, a Y axis, and a Z axis, which are orthogonal to each other, are shown appropriately. The X axis, Y axis, and Z axis define a fixed coordinate system that is fixed with respect to a multilayer ceramic capacitor. When the outer shape of the multilayer ceramic capacitor, which is an example of a multilayer ceramic electronic component, is a substantially rectangular parallelepiped shape, the X axis, Y axis, and Z axis can correspond to the length, width, and height of the multilayer ceramic capacitor.

### [Basic Structure of Multilayer Ceramic Capacitor]

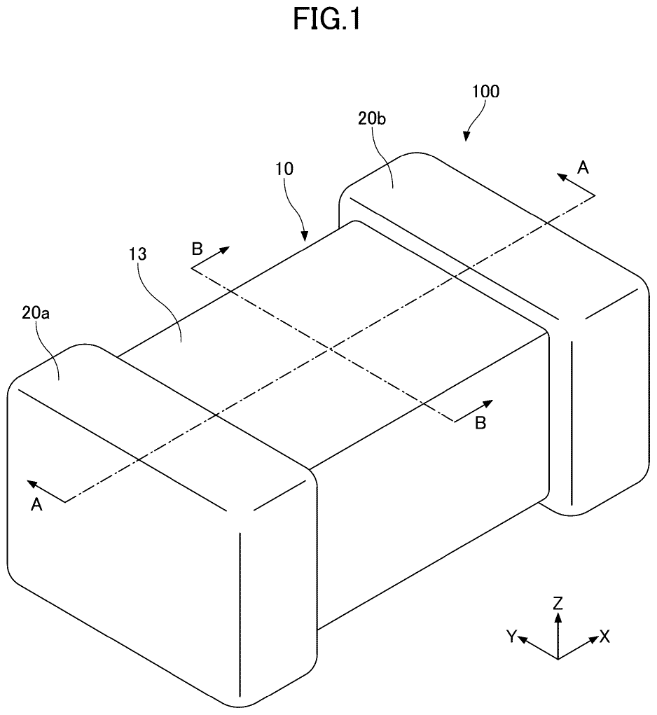

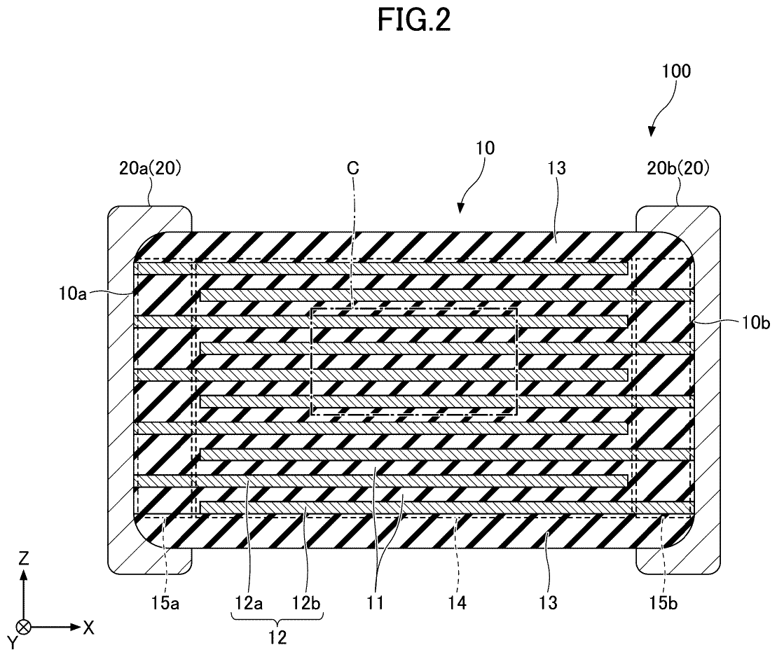

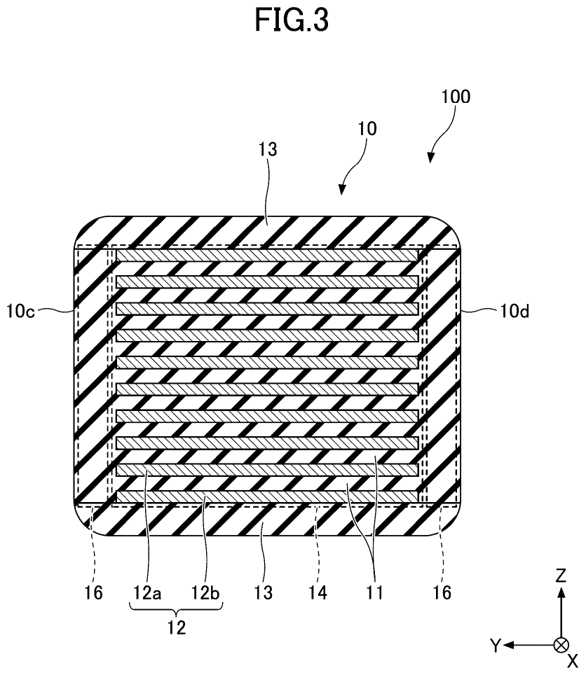

FIG. 1 is a perspective diagram of a multilayer ceramic capacitor 100 according to an embodiment of the present disclosure. FIG. 2 is a cross-sectional diagram taken along the line A-A of FIG. 1. FIG. 3 is a cross-sectional diagram taken along the line B-B of FIG. 1.

As illustrated in FIGS. 1 to 3, the multilayer ceramic capacitor 100 includes a body 10 having a substantially rectangular parallelepiped shape. Two opposing planes of the body 10 are referred to as an upper plane and a lower plane, and four planes connecting the upper plane and the lower plane are referred to as side planes. Typically, when a multilayer ceramic capacitor is mounted on a circuit board, a plane on the substrate side is referred to as a lower plane, which is, however, non-limiting.

In the example illustrated in FIGS. 1 to 3, a first external electrode 20a and a second external electrode 20b are respectively provided on a first side plane 10a and a second side plane 10b (see FIG. 2), which are two opposing side planes of the body 10.

The first external electrode 20a extends from the first side plane 10a to four planes next to the first side plane 10a. The second external electrode 20b extends from the second side plane 10b to four planes next to the second side plane 10b. Also, the first external electrode 20a and the second external electrode 20b are spaced from each other. The planes on which the external electrodes are provided are not limited to the two opposing side planes of the body 10 as long as the external electrodes are provided on the surface of the body 10.

The body 10 has a configuration in which dielectric material layers 11, containing a ceramic material functioning as a dielectric material, and internal electrode layers 12 are alternately laminated.

The internal electrode layers 12 include a plurality of first internal electrode layers 12a and a plurality of second internal electrode layers 12b. The first internal electrode layers 12a and the second internal electrode layers 12b are alternately laminated. Ends of the first internal electrode layers 12a are routed out to a surface of the body 10 on which the first external electrode 20a is provided, i.e., the first side plane 10a in FIGS. 1 to 3. Ends of the second internal electrode layers 12b are routed out to a surface of the body 10 on which the second external electrode 20b is provided, i.e., the second side plane 10b in FIGS. 1 to 3. With this configuration, the first internal electrode layers 12a and the second internal electrode layers 12b are alternately electrically connected to the first external electrode 20a and the second external electrode 20b. Therefore, the multilayer ceramic capacitor 100 has a configuration in which a plurality of capacitor units are laminated. The number of the dielectric material layers 11 and the number of the internal electrode layers 12 in FIGS. 1 to 3 are merely examples for ease of understanding of the description. The multilayer ceramic capacitor according to the present embodiment may include a larger number of laminated layers.

A lamination direction in which the dielectric material layers 11 and the internal electrode layers 12 are laminated is a first axis. As illustrated in FIGS. 1 to 3, when the first axis, i.e., the lamination direction, is a direction along the Z axis in the fixed coordinate system (Z-axis direction), the Z axis is the lamination direction in which the dielectric material layers 11 and the internal electrode layers 12 are laminated, and is a direction in which the internal electrode layers face each other.

An axis perpendicular to the first axis, i.e., the lamination direction, is a second axis. As illustrated in FIGS. 1 to 3, when the second axis perpendicular to the first axis, i.e., the lamination direction, is a direction along the X axis (X-axis direction), the X axis is a direction in which the internal electrode layers 12 are routed out and in which the first side plane 10a and the second side plane 10b of the body 10 face each other or the first external electrode 20a and the second external electrode 20b face each other. In the example illustrated in FIGS. 1 to 3, the electrode routed-out direction (X-axis direction) is a direction along a longitudinal direction of the body 10.

An axis perpendicular to the first axis, i.e., the lamination direction, and perpendicular to the second axis is a third axis. As illustrated in FIGS. 1 to 3, when the third axis perpendicular to the first axis, i.e., the lamination direction, and perpendicular to the second axis is a direction along the Y axis (Y-axis direction), the Y axis is an axis along a direction in which a third side plane 10c and a fourth side plane 10d of the four side planes of the body 10 face each other. In the example illustrated in FIGS. 1 to 3, the direction along the Y axis is a direction along a width direction of the body 10.

The X-axis direction, Y-axis direction, and Z-axis direction are orthogonal to each other. The lamination direction is not limited to a Z direction and may be any other direction. Therefore, for example, the first axis, i.e., the lamination direction, may be the X axis of an X direction or may be the Y axis of a Y direction.

In the present specification, for the description of general embodiments, a diagram illustrating a specific embodiment of the general embodiments may be used. However, the content described based on the coordinate system used in the specific embodiment is applied to general coordinate systems in the general embodiments in which the lamination direction is the first axis. For example, the X axis, Y axis, and Z axis used in FIGS. 1 to 3, in which the lamination direction coincides with the Z direction as the specific embodiment, can be applied to the general embodiments by reading the X axis, Y axis, and Z axis as the second axis, the third axis, and the first axis, respectively.

A region in which the first internal electrode layers 12a connected to the first external electrode 20a and the second internal electrode layers 12b connected to the second external electrode 20b face each other is referred to as a capacitor portion 14. The capacitor portion 14 is a region of the multilayer ceramic capacitor 100 in which electrical capacitance is generated. In other words, the capacitor portion 14 is a region in which adjacent internal electrode layers connected to the different external electrodes face each other via the dielectric material layer.

In the capacitor portion 14 in which the dielectric material layers 11 and the internal electrode layers 12 are laminated, the outermost portions in the lamination direction (Z-axis direction) are formed by the internal electrode layers 12. Also, cover layers 13 may be disposed on the outer planes of the capacitor portion 14 in the lamination direction, i.e., on the outer planes of the outermost internal electrode layers 12 in the lamination direction.

The cover layers 13 are layers containing a ceramic material functioning as a dielectric material. The cover layers 13 may have a composition the same as or different from the composition of the dielectric material layers 11.

As long as the first internal electrode layers 12a and the second internal electrode layers 12b are exposed to different regions of the surface of the body 10 and are electrically connected to different external electrodes, the configuration of the body 10 is not limited to the configuration illustrated in FIGS. 1 to 3. The different regions of the surface of the body 10 may be respective surface regions of opposing planes of the surface of the body 10, respective surface regions of planes next to each other, or different surface regions of the same plane. As long as the different external electrodes are spaced from each other, the external electrodes may extend, to other planes, from the planes of the laminate's surface regions to which the first internal electrode layers 12a and the second internal electrode layers 12b are exposed. Although not illustrated in FIGS. 1 to 3, the body 10 includes a plurality of intermediate regions 40 one of which is provided between one of the dielectric material layers 11 and one of the internal electrode layers 12, the one dielectric material layer 11 and the one internal electrode layer 12 being next to each other, which will be described in detail below.

A region in which the first internal electrode layers 12a connected to the first external electrode 20a face each other in the lamination direction without the second internal electrode layers 12b connected to the second external electrode 20b being interposed therebetween is referred to as a first end margin 15a. Also, a region in which the second internal electrode layers 12b connected to the second external electrode 20b face each other in the lamination direction without the first internal electrode layers 12a connected to the first external electrode 20a being interposed therebetween is referred to as a second end margin 15b. Each end margin is a region in which the internal electrode layers connected to the same external electrode face each other in the lamination direction without the internal electrode layers connected to the different external electrode being interposed therebetween. The first end margin 15a and the second end margin 15b are regions in which no electrical capacitance is generated.

As illustrated in FIG. 3, a region provided next to the outside of the capacitor portion 14 in the Y-axis direction is referred to as a side margin 16. The side margin is an outside region next to the capacitor portion 14 on the side where the internal electrode layers 12 are not routed out. The side margin 16 is a region in which no electrical capacitance is generated.

No particular limitation is imposed on the size of the multilayer ceramic capacitor 100, and the size of the multilayer ceramic capacitor 100 may be appropriately selected in accordance with the intended purpose. For example, the size of the multilayer ceramic capacitor 100 may be: 0.25 mm (millimeters) in length, 0.125 mm in width, and 0.125 mm in height; 0.4 mm in length, 0.2 mm in width, and 0.2 mm in height; 0.6 mm in length, 0.3 mm in width, and 0.3 mm in height; 1.0 mm in length, 0.5 mm in width, and 0.5 mm in height; 3.2 mm in length, 1.6 mm in width, and 1.6 mm in height; or 4.5 mm in length, 3.2 mm in width, and 2.5 mm in height. However, the above-listed sizes of the multilayer ceramic capacitor 100 are merely examples, and the size of the multilayer ceramic capacitor is not limited to the above sizes.

The size of the multilayer ceramic capacitor 100 may be, for example, as follows: length>width≥height; width>length≥height; height>length≥width; or height>width≥length. The ceramic capacitor 100 illustrated in FIGS. 1 to 3 has a length in the X-axis direction (electrode routed-out direction), a width in the Y-axis direction, and a height in the Z-axis direction (lamination direction).

### (Dielectric Material Layer)

Each of the dielectric material layers 11 contains a compound having a perovskite structure represented by the general formula ABO₃ (which may be referred to as a perovskite-type compound) as a main component. In the present specification, the description “containing a predetermined component as a main component” means that the predetermined component is contained in the largest amount in terms of a ratio by mol among the contained components.

No particular limitation is imposed on the amount of the perovskite-type compound contained in the dielectric material layers 11. The amount of the perovskite-type compound contained in the dielectric material layers 11 may be appropriately selected in accordance with the intended purpose, and may be, for example, 50 atomic % or more, 60 atomic % or more, 80 atomic % or more, 90 atomic % or more, or 95 atomic % or more. The perovskite structure may be deficient in oxygen compared to the stoichiometric composition. That is, the perovskite-type compound may be represented as ABO_{3-α} deviating from the stoichiometric composition (0<α≤1: α represents an amount deviating from the stoichiometric composition).

As the perovskite-type compound, it is possible to use one or more of, for example, barium titanate (BaTiO₃), calcium zirconate (CaZrO₃), calcium titanate (CaTiO₃), strontium titanate (SrTiO₃), magnesium titanate (MgTiO₃), and Ba_{1-x-y}CaₓSr_{y}Ti_{1-z}Zr_{z}O₃ (0≤x≤1, 0≤y≤1, 0≤z≤1) forming the perovskite structure.

Specific examples of Ba_{1-x-y}CaₓSr_{y}Ti_{1-z}Zr_{z}O₃ include strontium barium titanate, calcium barium titanate, barium zirconate, barium zirconate titanate, calcium zirconate titanate, calcium barium zirconate titanate, and the like.

Of these perovskite-type compounds, barium titanate (BaTiO₃) is preferable from the viewpoint of excellent dielectric characteristics, such as a high dielectric constant, small dielectric loss, and the like. When the dielectric material layers 11 contain barium titanate as the perovskite-type compound, the electrostatic capacitance of the multilayer ceramic capacitor 100 can be increased. The ceramic material in the dielectric material layers 11 preferably contains barium titanate as a main component. The dielectric material layers 11 may consist of barium titanate.

The dielectric material layers 11 may contain an additive other than the above-described ceramic material. No particular limitation is imposed on the additive, and the additive may be appropriately selected in accordance with the intended purpose. Examples of the additive include: simple substances or compounds containing one or more elements selected from zirconium (Zr), magnesium (Mg), manganese (Mn), molybdenum (Mo), vanadium (V), chromium (Cr), and rare earth elements (scandium (Sc), cerium (Ce), neodymium (Nd), yttrium (Y), samarium (Sm), europium (Eu), gadolinium (Gd), terbium (Tb), dysprosium (Dy), holmium (Ho), erbium (Er), thulium (Tm), and ytterbium (Yb)); simple substances or compounds containing one or more elements selected from cobalt (Co), nickel (Ni), lithium (Li), boron (B), sodium (Na), potassium (K), and silicon (Si); glass containing an oxide containing one or more elements selected from cobalt, nickel, lithium, boron, sodium, potassium, and silicon; and the like.

The dielectric material layers 11 may contain copper (Cu). When the dielectric material layers 11 contain copper, the concentration of copper in the dielectric material layers 11 is preferably 0.1 atomic % or less from the viewpoint of ensuring insulation of the dielectric material.

A thickness t (μm) of the dielectric material layers 11 is 1.6 μm (micrometers) or less. When the thickness of the dielectric material layers is changed, the interfacial ratio with the dielectric material layer is also changed. This changes the contribution of the increase in the interfacial resistance to the improvement in the lifetime characteristics. For example, when the thickness t of the dielectric material layers 11 is greater than 1.6 μm, the contribution to the improvement in the lifetime characteristics may decrease. Further, when the thickness t of the dielectric material layers 11 is greater than 1.6 μm, adverse effects on the capacitance characteristics may be non-negligible. When the thickness t of the dielectric material layers 11 is 1.6 μm or less, the capacitance characteristics can be sufficiently obtained. From the viewpoint of improving the capacitance characteristics, the thickness t (μm) of the dielectric material layers 11 is preferably 1.0 μm or less, more preferably 0.8 μm or less, and further preferably 0.5 μm or less.

No particular limitation is imposed on a measurement method of the thickness t (μm) of the dielectric material layers 11, and the measurement method may be appropriately selected in accordance with the intended purpose. For example, the thickness t (μm) of the dielectric material layers 11 can be evaluated through observation of a cross section of the multilayer ceramic capacitor 100. More specifically, the multilayer ceramic capacitor is abraded along the X-axis direction or the Y-axis direction to expose a YZ or XZ plane of the capacitor portion 14. Here, the plane to be exposed through abrasion is preferably a plane near the center of the capacitor portion 14 in the X-axis direction or the Y-axis direction. The exposed surface is imaged by a laser microscope or the like, and about 5 to about 10 layers are selected from each of the center portion, the upper end portion, and the lower end portion in the Z-axis direction, i.e., the lamination direction of the dielectric material layers 11 (a total of 15 to 20 dielectric material layers 11 are selected). The thickness (length in the Z-axis direction) of each of the selected dielectric material layers 11 is measured at positions corresponding to ¼, ½, and ¾ of the width of each dielectric material layer 11, and the average of the measurement values can be defined as the thickness (μm) of each dielectric material layer 11. The thicknesses of all the selected dielectric material layers 11 each measured in this manner are averaged, and the obtained average of the thicknesses of all the selected dielectric material layers 11 can be used as the thickness t (μm) of the dielectric material layers 11. The imaging by the laser microscope or the like may be performed by separating the dielectric material layers 11 into the center portion, the upper end portion, and the lower end portion in the Z-axis direction, which is the lamination direction of the dielectric material layers 11. Alternatively, the imaging by the laser microscope or the like may be performed by separating the dielectric material layers 11 at positions corresponding to ¼, ½, and ¾ of the width of each dielectric material layer.

In the multilayer ceramic capacitor of the present embodiment, preferably, the thickness t (μm) of the dielectric material layers 11 is 1.6 μm or less, and the electric field intensity of the multilayer ceramic capacitor is 50 V/μm or less.

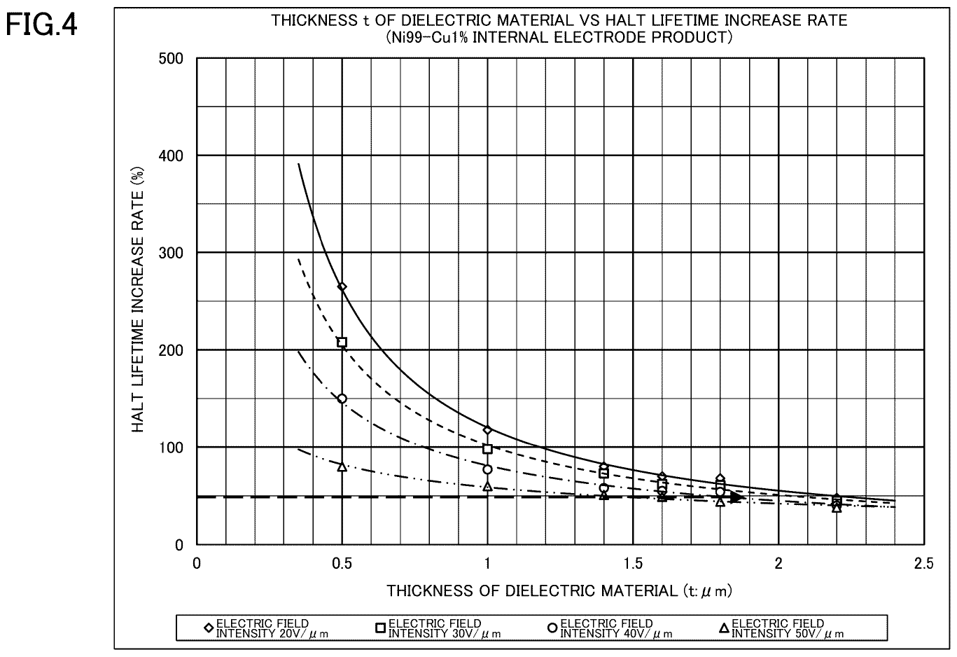

FIG. 4 is a graph of a highly accelerated limit test (HALT) lifetime increase rate of a multilayer ceramic capacitor containing 1% copper (Cu) in the internal electrode layers 12 compared to a conventional multilayer ceramic capacitor containing no copper (Cu) in the internal electrode layer. A measurement method of the HALT lifetime in FIG. 4 will be described below in the section of Examples. It is found from FIG. 4 that the HALT lifetime increase rate decreases as the thickness of the dielectric material layers 11 becomes greater than 1.6 μm and as the electric field intensity between the internal electrode layers 12 increases from 20 V/μm to 50 V/μm. When the thickness of the dielectric material layers 11 is 1.6 μm or less, even if the electric field intensity is 50 V/μm, excellent lifetime improvement is obtained, i.e., the HALT lifetime increase rate exceeds 50%.

The electric field intensity at the time of application of a rated voltage, which serves as a guide for a limit value at which the multilayer ceramic capacitor can be used constantly, can be calculated from the value of the rated voltage and the thickness of the dielectric material layers 11 between the internal electrode layers 12. The electric field intensity in an overload acceleration test, which may be used to indicate the quality level of a product of the multilayer ceramic capacitor, can be calculated from the value of an applied voltage in a high temperature operating life test, which is a typical overload acceleration test, and the thickness of the dielectric material layers 11 between the internal electrode layers 12. The applied voltage in the high temperature operating life test may be from 100% to 150% of the rated voltage, or up to 200% depending on the application of the product, in which the applied voltage is indicated in the product specification for each multilayer ceramic capacitor and determined by the manufacturer.

From the viewpoint that the HALT lifetime increase rate increases as the electric field intensity of the multilayer ceramic capacitor decreases, the electric field intensity of the multilayer ceramic capacitor is preferably 50 V/μm or less, more preferably 40 V/μm or less, further preferably 30 V/μm or less, and particularly preferably 20 V/μm or less. The electric field intensity of the multilayer ceramic capacitor is preferably the electric field intensity at the time of application of the rated voltage, and more preferably the electric field intensity at the time of high-temperature operation from the viewpoint of safety with respect to the HALT lifetime.

### (Internal Electrode Layer)

Each of the internal electrode layers 12 contains a metal or alloy as a main component. The main component contained in the internal electrode layers 12 may be a base metal, such as nickel (Ni), tin (Sn), or the like, or an alloy containing these. The main component contained in the internal electrode layers 12 may be a noble metal, such as platinum (Pt), palladium (Pd), silver (Ag), gold (Au), or the like, or an alloy containing these. Of these, the internal electrode layers 12 preferably contains Ni from the viewpoints of excellent electrical characteristics and cost reduction.

The main component contained in the first internal electrode layers 12a and the main component contained in the second internal electrode layers 12b may be the same as or different from each other.

The internal electrode layers 12 may contain copper (Cu). When the internal electrode layers 12 contain Ni as a main component, Cu may form an alloy with Ni. When the internal electrode layers 12 contain copper, the interfacial resistance between the internal electrode layer and the dielectric material layer is increased, thereby extending the lifetime of MLCCs.

No particular limitation is imposed on the concentration (atomic %) of copper in the internal electrode layers 12. The concentration (atomic %) of copper in the internal electrode layers 12 may be appropriately selected in accordance with the intended purpose, and is preferably 2.5 atomic % or less, more preferably 2 atomic % or less, further preferably 1.5 atomic % or less, and particularly preferably 1 atomic % or less. When the concentration (atomic %) of copper in the internal electrode layers 12 is set in the above range, it is possible to prevent reduction in continuity of the internal electrode layers 12 due to the melting point of the internal electrode layers 12 being lowered by an excess amount of copper contained in the internal electrode layers 12. Also, from the viewpoint of improving the lifetime characteristics, the concentration (atomic %) of copper in the internal electrode layers 12 is preferably 0.2 atomic % or more, more preferably 0.3 atomic % or more, and further preferably 0.5 atomic % or more.

No particular limitation is imposed on a measurement method of the concentration of copper in the internal electrode layers 12, and the measurement method may be appropriately selected in accordance with the intended purpose. For example, the concentration of copper in the internal electrode layers 12 may be an average of the concentrations (atomic %) of copper in regions on the internal electrode side excluding the intermediate regions 40, in a graph of a concentration distribution obtained through TEM-EDX analysis. When a strict boundary is required, the region of the internal electrode layers 12 may be a region in which the oxygen concentration is less than 5 atomic %. Here, the concentration of copper is a percentage of copper atoms relative to all the elements contained in the internal electrode layers 12.

No particular limitation is imposed on the thickness of the internal electrode layers 12. The thickness of the internal electrode layers 12 may be appropriately selected in accordance with the intended purpose, and is preferably 0.1 μm or greater and 1.5 μm or less and more preferably 0.3 μm or greater and 1.0 μm or less.

When the thickness of the internal electrode layers 12 is less than 0.1 μm, the continuity of the internal electrode becomes significantly smaller because the internal electrode layer is apt to diffuse and disappear during firing of the ceramic dielectric material. Therefore, it may be difficult to ensure the functions of the internal electrodes. When the thickness of the internal electrode layers 12 is 0.1 μm or greater, it is possible to ensure the functions of the internal electrodes. When the thickness of the internal electrode layers 12 is 1.5 μm or less, the electrostatic capacitance can be increased by increasing the number of laminated layers of the capacitor portion 14 even if the size of the multilayer ceramic capacitor is the same. In other words, the thickness of the internal electrode layers 12 is preferably 1.5 μm or less from the viewpoint of obtaining a smaller multilayer ceramic capacitor having the same performance. From the viewpoint of increasing the electrostatic capacitance by increasing the number of laminated layers, the thickness of the internal electrode layers 12 is preferably 0.5 μm or less and more preferably 0.4 μm or less.

No particular limitation is imposed on a measurement method of the thickness of the internal electrode layers 12, and the measurement method may be appropriately selected in accordance with the intended purpose. The thickness of the internal electrode layers 12 can be measured, for example, by a method similar to the measurement method of the thickness t of the dielectric material layers 11.

### (Intermediate Region)

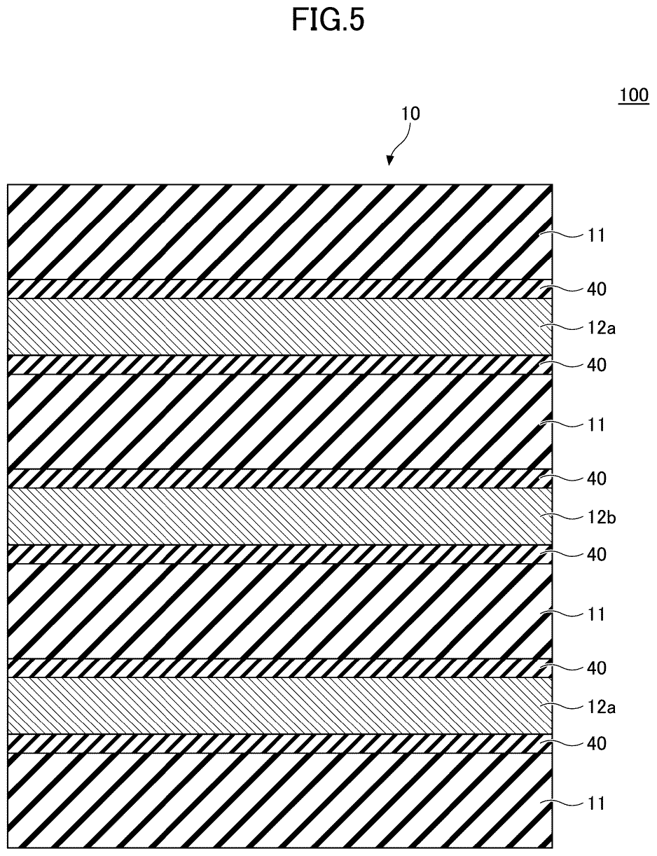

FIG. 5 is an enlarged diagram of region C of FIG. 2. As illustrated in FIG. 5, the multilayer ceramic capacitor 100 according to the present embodiment includes the intermediate regions 40, containing copper, between the dielectric material layers 11 and the internal electrode layers 12. Although FIG. 5 is a schematic diagram and illustrates the intermediate regions 40 as a continuous layer having a constant thickness, the intermediate regions 40 is not limited to the illustrated form. For example, the intermediate regions 40 may be discontinuous and may be different in thickness from place to place. In the production of the multilayer ceramic capacitor 100, the intermediate regions 40 may be formed through segregation of elements between the two layers in a firing step (which will be described below in detail) of firing a laminate including an unfired material for the formation of dielectric material layers to be the dielectric material layers 11 and an unfired material for the formation of internal electrode layers to be the internal electrode layers 12.

The intermediate regions 40 can be confirmed through observation of a cross section of the multilayer ceramic capacitor 100. For example, as described above regarding the measurement method of the thickness t of the dielectric material layers 11, the YZ or XZ plane of the capacitor portion 14 is exposed. The exposed plane is subjected to a line analysis along the Z-axis direction through energy dispersive X-ray spectroscopy (EDX) of a transmission electron microscope (TEM), thereby outputting a graph of a concentration distribution of the elements. In the obtained graph, a region in which the distributed range of the main component element of the internal electrode layers 12 and the distributed range of the main component element of the dielectric material layers 11 overlap with each other or a region in which there are a concentration gradient of the main component element of the internal electrode layers 12 and a concentration gradient of the main component element of the dielectric material layers 11 is determined as the intermediate regions 40. When a strict boundary is required, the intermediate regions 40 may be determined as a region in which the oxygen concentration is 5 atomic % or more and titanium (Ti) of the main component elements of the dielectric material layers 11 is 15 atomic % or less.

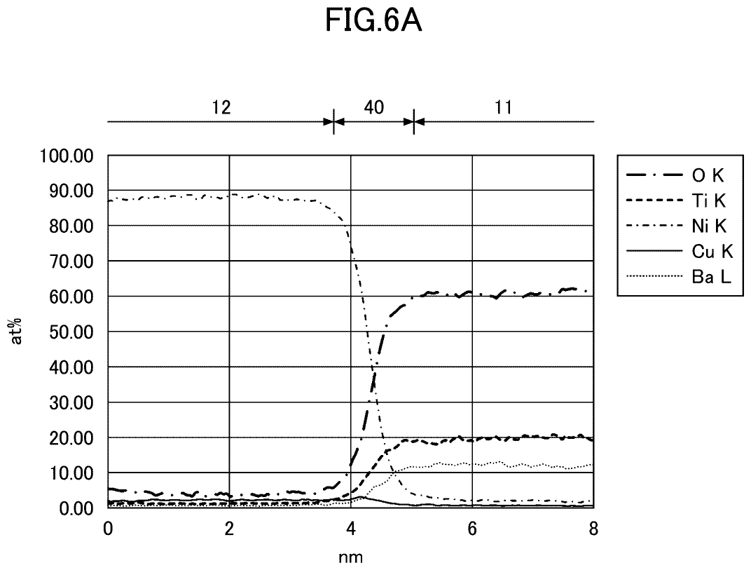

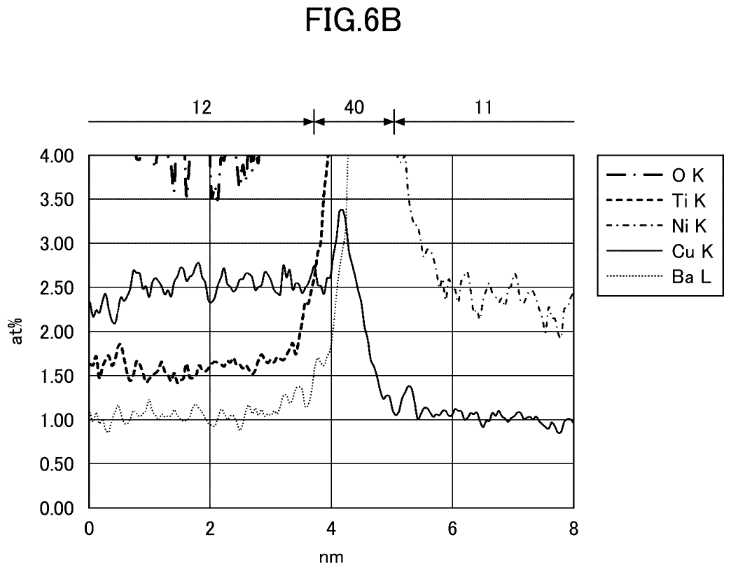

FIG. 6A is an example of a graph of the concentration distribution obtained through TEM-EDX analysis of the XZ plane exposed by abrading the multilayer ceramic capacitor 100 according to the present embodiment. FIG. 6B is a portion of the graph of FIG. 6A enlarged in the vertical-axis direction (an enlarged diagram corresponding to the concentration range from 0 atomic % to 4 atomic %). FIGS. 6A and 6B indicate analysis results of the multilayer ceramic capacitor 100 including the dielectric material layers 11 formed of barium titanate and the internal electrode layers 12 including nickel as a main component. From FIGS. 6A and 6B, a concentration gradient of nickel (Ni) and concentration gradients of oxygen (O), titanium (Ti), and barium (Ba) are found in the intermediate regions 40 between the dielectric material layers 11 and the internal electrode layers 12.

The intermediate regions 40 contain Cu. Cu is a different element, i.e., an element different from the main component element forming the dielectric material layers 11 and the main component element forming the internal electrode layers 12. Since such a different element exists between the dielectric material layers 11 and the internal electrode layers 12, the interfacial resistance between the dielectric material layers 11 and the internal electrode layers 12 can be increased, and high insulation reliability can be obtained over a long period of time. That is, the lifetime characteristics of the multilayer ceramic capacitor 100 can be improved.

The Cu contained in the intermediate regions 40 may be transferred, and then segregated, from the internal electrode layers 12 and/or the dielectric material layers 11, preferably from the internal electrode layers 12, in the firing step in the production of the multilayer ceramic capacitor 100. Since Cu is easily diffused compared to other elements, a sufficient amount of Cu can be segregated between the internal electrode layers 12 and the dielectric material layers 11 during the production process of the multilayer ceramic capacitor 100, thereby easily increasing the interfacial resistance.

### —Concentration of Cu—

As described above, in the multilayer ceramic capacitor 100 according to the present embodiment, Cu exists in the intermediate regions 40. The present inventors intensively studied the concentration of copper in the intermediate regions and the characteristics of the multilayer ceramic capacitor 100. As a result, the present inventors have found that, when a ratio [a/t] of the concentration a (atomic %) of copper in the intermediate regions 40 to the thickness t (μm) of the dielectric material layers 11 is 0.8 or more and 7.0 or less, the multilayer ceramic capacitor 100 having a long lifetime and excellent dielectric characteristics can be provided.

Furthermore, the present inventors have found that, when the ratio [a/t] is 1.5 or more and 3.0 or less, the multilayer ceramic capacitor 100 having a long lifetime and more excellent dielectric characteristics can be provided. In the present specification, the term “excellent dielectric characteristics” refers to sufficient electrostatic capacitance.

As such, in the multilayer ceramic capacitor 100 according to the present embodiment, the ratio [a/t] of the concentration a (atomic %) of copper in the intermediate regions to the thickness t (μm) of the dielectric material layers is 0.8 or more and 7.0 or less. With such a configuration, a long lifetime and excellent dielectric characteristics can be ensured, and high reliability can be achieved.

The lifetime characteristics of the multilayer ceramic capacitor 100 can be evaluated based on the length of a period required for the insulation resistance to decrease to a predetermined value in a high temperature operating life test. For this evaluation, for example, a highly accelerated limit test (HALT) can be used. In the highly accelerated limit test, a voltage that achieves a predetermined electric field intensity (e.g., a voltage that achieves 25 V/μm at 150° C.) is continuously applied at a predetermined temperature, and a period required for half of the tested multilayer ceramic capacitors to exceed a threshold of a leak current is defined as a HALT lifetime 50% value. The higher the HALT lifetime 50% value, the longer the lifetime.

No particular limitation is imposed on the concentration a (atomic %) of copper in the intermediate regions 40 as long as the above ratio [a/t] is satisfied. The concentration a (atomic %) of copper in the intermediate regions 40 may be appropriately selected in accordance with the intended purpose, and is preferably 1 atomic % or more and 4.5 atomic % or less, more preferably 1.2 atomic % or more and 4 atomic % or less, further preferably 1.3 atomic % or more and 3 atomic % or less, and particularly preferably 1.5 atomic % or more and 2.5 atomic % or less.

When the concentration a (atomic %) of copper in the intermediate regions 40 is 1 atomic % or more, Cu is distributed to cover the internal electrode layers 12 in a sufficient area. Thus, it is possible to increase the interfacial resistance and obtain high lifetime characteristics. Also, when the concentration a (atomic %) of copper in the intermediate regions 40 is 4.5 atomic % or less, it is possible to avoid reduction in insulation due to the excess amount of Cu contained in the intermediate regions 40, and obtain excellent electrostatic characteristics. Especially, when the concentration a (atomic %) of copper in the intermediate regions 40 is 2.5 atomic % or less, it is possible to ensure high electrostatic capacitance.

The concentration a (atomic %) of copper in the intermediate regions 40 may be a value obtained through TEM-EDX analysis performed on a surface exposed through abrasion in the same manner as the method described regarding the confirmation of the intermediate regions 40. In the present specification, the concentration a (atomic %) of copper in the intermediate regions 40 refers to a maximum value of the concentration (atomic %) of copper in a region recognized as the intermediate regions 40 in a graph of the concentration distribution obtained through TEM-EDX analysis. The graph of the concentration distribution to be used is a graph after removal of the background noise derived from the apparatus.

### [Production Method of Multilayer Ceramic Capacitor]

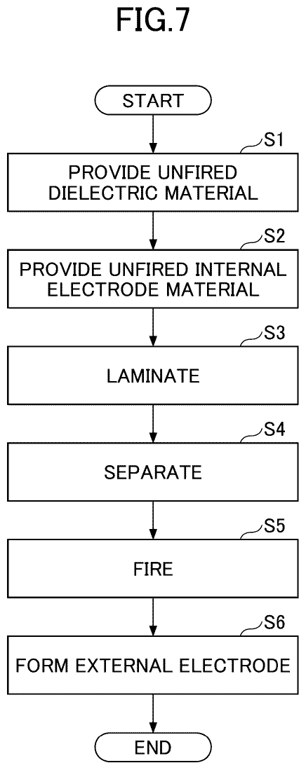

Next, a production method of the multilayer ceramic capacitor 100 will be described. An embodiment of the present disclosure may be a production method of the multilayer ceramic capacitor that includes: the body including the dielectric material layer and the internal electrode layer that are alternately laminated; and the intermediate region between the dielectric material layer and the internal electrode layer, in which the dielectric material layers contain the perovskite-type compound represented by the general formula ABO₃ and the intermediate regions contain copper. The production method of the multilayer ceramic capacitor includes: a lamination step of alternately laminating an unfired dielectric material to be the dielectric material layer and an unfired internal electrode material to be the internal electrode layer, thereby obtaining a laminate; and a firing step of firing the laminate, in which the ratio [a/t] of the concentration a (atomic %) of copper in the intermediate regions to the thickness t (μm) of the dielectric material layer is 0.8 or more and 7.0 or less. FIG. 7 is a flowchart illustrating the production method of the multilayer ceramic capacitor 100 according to the embodiment.

### (Unfired Dielectric Material Providing Step (S1))

In the unfired dielectric material providing step (S1), a ceramic green sheet (unfired dielectric material) to be the dielectric material layers 11 through firing is provided.

First, a ceramic powder for the formation of the dielectric material layers is provided. The ceramic powder may be a powder of the above-described ceramic material for the dielectric material layers 11 of the multilayer ceramic capacitor 100. Therefore, the ceramic powder may contain a powder of the perovskite-type compound represented by the general formula ABO₃, and preferably contains barium titanate.

Barium titanate can be typically obtained by reacting a titanium raw material, such as titanium dioxide or the like, with a barium raw material, such as barium carbonate or the like.

No particular limitation is imposed on a synthesis method of the ceramic powder to be the ceramic material serving as a main component of the dielectric material layers 11, and the synthesis method may be appropriately selected in accordance with the intended purpose. Examples of the synthesis method include a solid-phase method, a sol-gel method, a hydrothermal method, and the like.

A predetermined additive may be added to the ceramic powder for the formation of the dielectric material layers in accordance with the intended purpose. The ceramic powder for the formation of the dielectric material layers is mixed through a wet process with or without addition of an additive, followed by drying and then pulverizing. Subsequently, a binder, such as a polyvinyl butyral (PVB) resin or the like, an organic solvent, such as ethanol, toluene, or the like, and a plasticizer are added to the obtained powder for the formation of the dielectric material layers, followed by mixing through a wet process to prepare a slurry for the formation of the dielectric material layers. The obtained slurry for the formation of the dielectric material layers is coated on a base, such as a polyethylene terephthalate (PET) film or the like, by a method, such as a die coater method, a doctor blade method, or the like, followed by drying to obtain the ceramic green sheet (unfired dielectric material).

### (Unfired Internal Electrode Material Providing Step (S2))

In the unfired internal electrode material providing step (S2), an unfired internal electrode material to be the internal electrode layers 12, i.e., the first internal electrode layers 12a and the second internal electrode layers 12b, is provided. A metal serving as a main component of the unfired internal electrode material may be a metal material similar to the above-described material for the internal electrode layers 12 of the multilayer ceramic capacitor 100, such as a base metal, such as Ni, Sn, or the like, or an alloy containing these. Also, the metal material may be a noble metal, such as Pt, Pd, Ag, Au, or the like, or an alloy containing these. From the viewpoints of excellent electrical characteristics and cost reduction, the metal material preferably contains Ni, and more preferably contains Ni as a main component.

Cu is added to the metal material. Then, the metal material containing Cu, an organic binder, and a solvent are kneaded to obtain a metal paste (unfired internal electrode material). Cu may be added after the metal paste is prepared from the metal material serving as the main component. Cu is preferably added as an oxide from the viewpoint of facilitating diffusion into the intermediate regions 40 during the firing process. Examples of the oxide of Cu include a copper oxide and the like.

The amount of Cu in the unfired internal electrode material can be adjusted such that the ratio [a/t] of the concentration a (atomic %) of copper in the intermediate regions after the firing step (S5) to the thickness t (μm) of the dielectric material layer after the firing step (S5) is 0.8 or more and 7.0 or less. Since the interfacial resistance between the dielectric material layers 11 and the internal electrode layers 12 can be increased by adjusting the amount of Cu to be added as described above, high insulation reliability over a long period of time, i.e., high lifetime characteristics, can be obtained. In this manner, according to the present embodiment, it is possible to produce the multilayer ceramic capacitor 100 having both excellent lifetime characteristics and excellent electrostatic characteristics.

In the present embodiment, during the production process of the multilayer ceramic capacitor, the amount of Cu to be added can be adjusted in accordance with the above ratio [a/t], which represents a relationship between the thickness t (μm) of the dielectric material layers 11 and the concentration a (atomic %) of copper in the intermediate regions 40. Therefore, for example, even if producing the multilayer ceramic capacitor in accordance with a new design in which the thickness t of the dielectric material layers 11 is changed, the amount of Cu to be added can be easily adjusted. This can produce a highly reliable product even if producing a multilayer ceramic capacitor in accordance with a new design.

A ceramic powder may be added, as a co-existing material, to the metal paste (unfired internal electrode material). No particular limitation is imposed on the main component of the ceramic powder, and the main component of the ceramic powder is preferably the same as the ceramic powder used in the unfired dielectric material providing step (S1). When a ceramic powder is added as a co-existing material, the ceramic powder may be added at the time of kneading the metal paste.

### (Lamination Step (S3))

In the lamination step (S3), using a method, such as screen printing, gravure printing, or the like, the metal paste obtained in the unfired internal electrode material providing step (S2) is printed on the surface of the ceramic green sheet obtained in the unfired dielectric material providing step (S1). This can dispose, on the surface of the ceramic green sheet, a first internal electrode pattern to be the first internal electrode layers 12a and a second internal electrode pattern to be the second internal electrode layers 12b. A formation method of the internal electrode patterns is not limited to printing, and can be another method using a mask, such as plating, vacuum vapor deposition, sputtering, chemical vapor deposition (CVD), or the like.

The ceramic green sheet on which the metal paste is printed is laminated such that the internal electrode layers 12 are alternately routed out to a pair of the external electrodes 20a and 20b, which are disposed in the longitudinal direction (X-axis direction) of the dielectric material layers 11. For this lamination, a publicly known technique can be used. For example, for forming the side margin 16 to be an outer region in the Y-axis direction in a portion of the capacitor portion 14 to which the internal electrode layers 12 are not routed out, an unfired dielectric material can be disposed in a peripheral region in which the internal electrode pattern of the metal paste is not printed. When the ceramic green sheet on which the metal paste is printed is regarded as a laminated unit, the number of layers of the laminated unit can be 100 or more and 500 or less.

Subsequently, a laminate is obtained by respectively laminating cover sheets, which are unfired cover materials for the formation of cover layers, on the top and bottom of the laminate in which the ceramic green sheet and the internal electrode pattern were obtained, i.e., on both sides in the lamination direction (Z-axis direction). The cover sheets may be formed, mainly using a ceramic powder, by the same method as that used for forming the unfired dielectric material for the formation of the dielectric material layers. Also, the cover sheets may be formed from the same material as that of the unfired dielectric material for the formation of the dielectric material layers. The number of laminated cover sheets may be 2 or more and 10 or less per one side.

The obtained laminate is pressure-bonded in the lamination direction (Z-axis direction) to obtain a pressure-bonded body.

### (Separation Step (S4))

The pressure-bonded body can be separated by being cut to a predetermined size through dicing with a dicer, laser cutting, or the like. An existing technique can be appropriately used as a separation method of the pressure-bonded body.

### (Firing Step (S5))

In the firing step (S5), the separated laminates are fired. No particular limitation is imposed on firing conditions, and the firing conditions may be appropriately selected in accordance with the intended purpose. The hydrogen concentration is preferably 0.03% by volume or more and 1.0% by volume or less, and more preferably 0.05% by volume or more and 0.3% by volume or less. The composition of a reducing atmosphere other than hydrogen is nitrogen or argon. In the firing step (S5), Cu previously added to an unsintered material segregates or diffuses to the interface, thereby forming the intermediate regions 40.

The firing temperature in the firing step (S5) is preferably 1,000° C. or higher and 1,350° C. or lower, and more preferably 1,150° C. or higher and 1,300° C. or lower. The firing time in the firing step (S5) may be 30 minutes or greater and 2 hours or less.

### (External Electrode Forming Step (S6))

In the external electrode forming step, the first external electrode 20a and the second external electrode 20b can be formed through plating or the like. Thus, the multilayer ceramic capacitor 100 described above is completed.

### EXAMPLES

Hereinafter, the present disclosure will be described in more detail by way of Examples.

### <Production of Multilayer Ceramic Capacitor 1A>

A polyvinyl butyral (PVB) resin, a solvent, a plasticizer, a sintering aid powder, which is an Si compound, and an additive, such as a rare earth element or the like, were added to a ceramic powder of barium titanate, followed by mixing through a wet process to prepare a ceramic slurry. The ceramic slurry was coated on a base film using a doctor blade to form a dielectric green sheet having a thickness after sintering of 0.5 μm.

Cu was added to a nickel powder in the form of a copper oxide (CuO) powder, followed by mixing to prepare a powder mixture. A polyvinyl butyral (PVB) resin, a solvent, and a plasticizer were added to the powder mixture, followed by kneading to obtain a metal paste (Cu-containing Ni paste) for the formation of the internal electrode layers. The amount of the copper oxide added to the metal paste was adjusted such that the concentration of copper in the intermediate regions after sintering would be 1.2 atomic %. The metal paste was printed on the dielectric green sheet to form an internal electrode layer pattern.

Five hundred dielectric green sheets on which the metal paste was printed were laminated. Further, dielectric green sheets serving as the cover layers were disposed on both sides in the lamination direction to form a laminate.

The obtained laminate was pressure-bonded, and then cut to a predetermined size to obtain separated shaped chips. The obtained shaped chips were subjected to a binder removing treatment in an N₂ atmosphere, and a metal paste to be a base layer of the external electrode was coated thereon by a dip method. Subsequently, the shaped chips were placed in a firing furnace, and fired for 10 minutes in the firing furnace in which the temperature of the firing furnace (firing temperature) was increased to 1,200° C. in an atmosphere having an H₂ concentration of 0.1% by volume and an N₂ concentration of 99.9% by volume. The external electrodes were formed on the fired shaped chips through plating, thereby producing a multilayer ceramic capacitor (MLCC) having a dimension of 1.0 mm×0.5 mm×0.5 mm.

### [Measurement of Thickness t of Dielectric Material Layer]

The produced multilayer ceramic capacitor was abraded from the external electrodes toward the center (i.e., along the X-axis direction) to expose the YZ plane in which the dielectric material layers and the internal electrode layers were laminated. The exposed YZ plane was imaged by a laser microscope, and 5 layers were selected from each of the center portion, the upper end portion, and the lower end portion in the Z-axis direction, i.e., the lamination direction of the dielectric material layers (a total of 15 dielectric material layers were selected). The thickness (μm) of each dielectric material layer in the Z-axis direction was measured at positions corresponding to ¼, ½, and ¾ of the width of each dielectric material layer, and the average of the measurement values was defined as the thickness (μm) of each dielectric material layer. The thicknesses of all the selected dielectric material layers each measured in this manner were averaged, and the obtained average of the thicknesses of all the selected dielectric material layers was used as the thickness t (μm) of the dielectric material layers.

### [Measurement of Concentration a of Copper in Intermediate Region]

Similar to the [Measurement of Thickness t of Dielectric Material Layer], the YZ plane of the produced multilayer ceramic capacitor was exposed. Near the center in the Z-axis direction, a line analysis through transmission electron microscopy-energy dispersive X-ray spectroscopy (TEM-EDX) was performed, along the Z-axis direction, on a range from one of the internal electrode layers to the dielectric material layer next to this internal electrode layer. In a graph of a concentration distribution of the number of atoms of each element obtained by the line analysis, the maximum value of the concentration of Cu was calculated in a region corresponding to the intermediate region in which the oxygen concentration was 5 atomic % or more and Ti of the main component elements of the dielectric material layer was 15 atomic % or less. By the same method, the maximum value in the intermediate region was calculated at a total of 3 locations, and the average of the values was defined as the concentration a (atomic %) of copper in the intermediate regions. The concentration a of copper is the concentration (atomic %) of Cu relative to all the elements detected through the analysis, and is a value excluding the background noise derived from the measurement apparatus.

### <Production of Multilayer Ceramic Capacitors 2A to 9A and Multilayer Ceramic Capacitors 1B to 10B>

Multilayer ceramic capacitors were produced in the same manner as in <Production of Multilayer Ceramic Capacitor 1A> except that the thickness t of the dielectric material layer and the concentration a of copper in the intermediate regions were changed as shown in Tables 1 and 3. Multilayer ceramic capacitors 1B to 7B were produced using a metal paste (Ni paste containing no Cu).

### Examples 1 to 9 and Comparative Examples 1 to 10

The electrostatic capacitance and lifetime characteristics of the obtained multilayer ceramic capacitors were measured in the following manners. The results are shown in Tables 2 and 4.

### [Measurement of Electrostatic Capacitance]

The produced multilayer ceramic capacitors were left to stand at 150° C. for 1 hour, and then left to stand at the standard condition (25° C. and 1 atm) for 24 hours. Subsequently, the electrostatic capacitance (μF) was measured using an LCR meter (HP 4284A, obtained from Keysight Technologies) at a voltage of 0.5 V and a frequency of 1 kHz. The absolute values of differences between the electrostatic capacitances of the Cu-free multilayer ceramic capacitors 1B to 7B and the electrostatic capacitances of the Cu-containing multilayer ceramic capacitors 1A to 9A and 8B to 10B were defined as A electrostatic capacitance. Specifically, the A electrostatic capacitance was determined in accordance with the following formula: A Electrostatic capacitance (%)=|(Electrostatic capacitance of Cu-containing multilayer ceramic capacitor−Electrostatic capacitance of Cu-free multilayer ceramic capacitor)/Electrostatic capacitance of Cu-free multilayer ceramic capacitor|.

For the calculation of the A electrostatic capacitance, the multilayer ceramic capacitors including the dielectric material layers having the same thickness t were compared (e.g., the multilayer ceramic capacitor 1A versus the multilayer ceramic capacitor 1B, and the multilayer ceramic capacitor 7A versus the multilayer ceramic capacitor 4B). The obtained Δ electrostatic capacitance was evaluated in accordance with the following evaluation criteria, and evaluated as “Good”, “Fair”, and “Bad”. Note that “Good” and “Fair” were regarded as pass, and “Bad” was regarded as fail.

### —Evaluation Criteria—

Good: The Δ electrostatic capacitance is 5% or less.
Fair: The Δ electrostatic capacitance is more than 5% and equal to or less than 15%.
Bad: The Δ electrostatic capacitance is more than 15%.

### [Measurement of Lifetime Characteristics]

The lifetime characteristics were evaluated in a highly accelerated lifetime test (HALT). A voltage that achieves an electric field intensity of 25 V/μm at 150° C. was applied to each of the produced twenty multilayer ceramic capacitors, and a leak current was measured over time. The period required for 50% of the samples to have the leak current of 2,000 μA was recorded as the HALT lifetime 50% value. From the HALT lifetime 50% value of the Cu-free multilayer ceramic capacitors 1B to 7B and the HALT lifetime 50% value of the Cu-containing multilayer ceramic capacitors 1A to 9A and 8B to 10B, the HALT lifetime increase rate was calculated in accordance with the following formula:

HALT lifetime increase rate=(HALT lifetime 50% value of Cu-containing multilayer ceramic capacitor−HALT lifetime 50% value of Cu-free multilayer ceramic capacitor)/HALT lifetime 50% value of Cu-free multilayer ceramic capacitor.

For the calculation of the HALT lifetime increase rate, the multilayer ceramic capacitors including the dielectric material layers having the same thickness t were compared (e.g., the multilayer ceramic capacitor 1A versus the multilayer ceramic capacitor 1B, and the multilayer ceramic capacitor 7A versus the multilayer ceramic capacitor 4B). The obtained HALT lifetime increase rate was evaluated in accordance with the following evaluation criteria, and evaluated as “Good”, “Fair”, and “Bad”. Note that “Good” and “Fair” were regarded as pass, and “Bad” was regarded as fail.

### —Evaluation Criteria—

Good: The HALT lifetime increase rate is 150% or more.
Fair: The HALT lifetime increase rate is equal to or more than 50% and less than 150%.
Bad: The HALT lifetime increase rate is less than 50%.

TABLE 1

| | Multilayer | Thickness | Concentration a | |
|---|---|---|---|---|
| | ceramic | t of | of copper in | |
| | capacitor | dielectric | intermediate | Ratio |
| | No. | material (μm) | region (atomic %) | a/t |
| Ex. 1 | 1A | 0.5 | 1.2 | 2.4 |
| Ex. 2 | 2A | 0.53 | 1.2 | 2.3 |
| Ex. 3 | 3A | 0.62 | 0.5 | 0.8 |
| Ex. 4 | 4A | 0.62 | 1.2 | 1.9 |
| Ex. 5 | 5A | 0.62 | 2.5 | 4 |
| Ex. 6 | 6A | 0.62 | 3.4 | 5.5 |
| Ex. 7 | 7A | 0.8 | 1.7 | 2.1 |
| Ex. 8 | 8A | 1.2 | 2.6 | 2.2 |
| Ex. 9 | 9A | 1.6 | 3.3 | 2.1 |

TABLE 2

| | | | | HALT | HALT | |
|---|---|---|---|---|---|---|
| | | \|Δ | | lifetime | lifetime | |
| | Electrostatic | Electrostatic | | 50% | increase | |
| | capacitance | capacitance\| | Evaluation | (min) | rate | Evaluation |
| Ex. 1 | 28.2 | 5% | Good | 1003 | 256% | Good |
| Ex. 2 | 26.9 | 4% | Good | 895 | 199% | Good |
| Ex. 3 | 24 | 0% | Good | 680 | 79% | Fair |
| Ex. 4 | 23.1 | 4% | Good | 1004 | 164% | Good |
| Ex. 5 | 22 | 8% | Fair | 1910 | 403% | Good |
| Ex. 6 | 21.3 | 11% | Fair | 2996 | 688% | Good |
| Ex. 7 | 17.9 | 4% | Good | 1242 | 153% | Good |
| Ex. 8 | 11.9 | 4% | Good | 1707 | 133% | Fair |
| Ex. 9 | 9 | 3% | Good | 2302 | 127% | Fair |

TABLE 3

| | Multilayer | Thickness t | Concentration a | |
|---|---|---|---|---|
| | ceramic | of dielectric | of copper in | |
| | capacitor | material | intermediate | Ratio |
| | No. | (μm) | region (atomic %) | a/t |
| Comp. Ex. 1 | 1B | 0.5 | — | — |
| Comp. Ex. 2 | 2B | 0.53 | — | — |
| Comp. Ex. 3 | 3B | 0.62 | — | — |
| Comp. Ex. 4 | 4B | 0.8 | — | — |
| Comp. Ex. 5 | 5B | 1.2 | — | — |
| Comp. Ex. 6 | 6B | 1.6 | — | — |
| Comp. Ex. 7 | 7B | 2 | — | — |
| Comp. Ex. 8 | 8B | 0.62 | 0.3 | 0.5 |
| Comp. Ex. 9 | 9B | 0.62 | 4.5 | 7.3 |
| Comp. Ex. 10 | 10B | 2 | 4.5 | 2.3 |

TABLE 4

| | | | | HALT | HALT | |
|---|---|---|---|---|---|---|
| | | \|Δ | | lifetime | lifetime | |
| | Electrostatic | Electrostatic | | 50% | increase | |
| | capacitance | capacitance\| | Evaluation | (min) | rate | Evaluation |
| Comp. Ex. 1 | 29.8 | — | Good | 282 | — | Bad |
| Comp. Ex. 2 | 28.1 | — | Good | 299 | — | Bad |
| Comp. Ex. 3 | 24 | — | Good | 380 | — | Bad |
| Comp. Ex. 4 | 18.6 | — | Good | 491 | — | Bad |
| Comp. Ex. 5 | 12.4 | — | Good | 732 | — | Bad |
| Comp. Ex. 6 | 9.3 | — | Good | 1012 | — | Bad |
| Comp. Ex. 7 | 7.4 | — | Good | 1420 | — | Bad |
| Comp. Ex. 8 | 24 | 0% | Good | 410 | 8% | Bad |
| Comp. Ex. 9 | 19.9 | 17% | Bad | 3712 | 877% | Good |
| Comp. Ex. 10 | 7.1 | 4% | Good | 1430 | 1% | Bad |

In Tables 1 to 4, “Ex.” stands for “Example”, and “Comp. Ex.” stands for “Comparative Example”. As shown in Table 2, Examples 1 to 4 and Examples 7 to 9, in which the ratio [a/t] is 3.0 or less, show good results with the changes in electrostatic capacitance being small. Examples 1 and 2 and Examples 4 to 7, in which the ratio [a/t] is 1.5 or more, show good results with the HALT lifetime increase rates being high.

Comparative Examples 1 to 7, in which no Cu is contained in the intermediate region, are bad with the HALT lifetime increase rates being low. In Comparative Example 8, in which the ratio [a/t] was less than 0.8, low improvement or substantially no improvement in the HALT lifetime was observed, i.e., bad. In Comparative Example 9, in which the ratio [a/t] was more than 7.0, the continuity of the internal electrode was degraded, and thus the electrostatic capacitance was not maintained, i.e., bad. In Comparative Example 10, in which the thickness of the dielectric material layers was more than 1.6 μm, the interfacial ratio with the dielectric material layer was low, and thus the interfacial effect that the increase in the interfacial resistance contributes to the improvement in the lifetime characteristics was not obtained. As a result, the HALT lifetime increase rate was low, i.e., bad.

Although the embodiments of the present disclosure have been described above in detail, the present disclosure is not limited to the above-described embodiments. Various changes, modification, substitutions, additions, deletions, combinations, and the like are possible in the above-described embodiments within the scope of claims recited.

The embodiments of the present disclosure are, for example, as follows.

<1> A multilayer ceramic capacitor, including:
a body including a plurality of dielectric material layers and a plurality of internal electrode layers that are alternately laminated; and
a plurality of intermediate regions one of which is provided between one dielectric material layer of the plurality of dielectric material layers and one internal electrode layer of the plurality of internal electrode layers, the one dielectric material layer and the one internal electrode layer being next to each other, in which
the dielectric material layers contain a perovskite-type compound represented by general formula ABO₃,
the intermediate regions contain copper,
a thickness of the dielectric material layers is 1.6 μm or less, and
a ratio [a/t] is 0.8 or more and 7.0 or less, where a of the ratio [a/t] is a concentration (atomic %) of the copper in the intermediate regions, and t of the ratio [a/t] is the thickness (μm) of the dielectric material layers.

<2> The multilayer ceramic capacitor according to <1>, in which the ratio [a/t] is 1.5 or more and 3.0 or less.

<3> The multilayer ceramic capacitor according to <1> or <2>, in which the thickness of the dielectric material layers is 1.0 μm or less.

<4> The multilayer ceramic capacitor according to any one of <1> to <3>, wherein an electric field intensity is 50 V/μm or less.

<5> The multilayer ceramic capacitor according to <4>, in which the electric field intensity is determined from a rated voltage of the multilayer ceramic capacitor, and the thickness of the dielectric material layers.

<6> The multilayer ceramic capacitor according to <4>, in which
the electric field intensity is determined from an applied voltage in a high temperature operating life test of the multilayer ceramic capacitor, and the thickness of the dielectric material layers.

<7> The multilayer ceramic capacitor according to any one of <1> to <6>, in which the internal electrode layers contain nickel.

<8> The multilayer ceramic capacitor according to any one of <1> to <7>, in which the perovskite-type compound represented by general formula ABO₃ contains barium titanate.

What is claimed is:

1. A multilayer ceramic capacitor, comprising:
a body including a plurality of dielectric material layers and a plurality of internal electrode layers that are alternately laminated; and
a plurality of intermediate regions one of which is provided between one dielectric material layer of the plurality of dielectric material layers and one internal electrode layer of the plurality of internal electrode layers, the one dielectric material layer and the one internal electrode layer being next to each other, wherein
the dielectric material layers contain a perovskite-type compound represented by general formula ABO₃,
the intermediate regions contain copper,
a thickness of the dielectric material layers is 1.6 μm or less, and
a ratio [a/t] is 0.8 or more and 7.0 or less, where a of the ratio [a/t] is a concentration (atomic %) of the copper in the intermediate regions, and t of the ratio [a/t] is the thickness (μm) of the dielectric material layers.

2. The multilayer ceramic capacitor according to claim 1, wherein
the ratio [a/t] is 1.5 or more and 3.0 or less.

3. The multilayer ceramic capacitor according to claim 1, wherein
the thickness of the dielectric material layers is 1.0 μm or less.

4. The multilayer ceramic capacitor according to claim 1, wherein
an electric field intensity is 50 V/μm or less.

5. The multilayer ceramic capacitor according to claim 4, wherein
the electric field intensity is determined from a rated voltage of the multilayer ceramic capacitor and the thickness of the dielectric material layers.

6. The multilayer ceramic capacitor according to claim 4, wherein
the electric field intensity is determined from an applied voltage in a high temperature operating life test of the multilayer ceramic capacitor, and the thickness of the dielectric material layers.

7. The multilayer ceramic capacitor according to claim 1, wherein
the internal electrode layers contain nickel.

8. The multilayer ceramic capacitor according to claim 1, wherein
the perovskite-type compound represented by the general formula ABO₃ contains barium titanate.
